(19) United States
(12) Patent Application Publication
(10) Pub. No.: US 2009/0184943 A1
(43) Pub. Date: Jul. 23, 2009

(54) Displaying Information Interactively

(75) Inventors: Markus Gross, Uster (CH); Daniel Cotting, Zurich (CH)

Correspondence Address: RANKIN, HILL & CLARK LLP, 38210 Glenn Avenue, WILLOUGHBY, OH, 44094-7808, US

(73) Assignee: EIDGENOSSISCHE TECHNISCHE HOCHSCHULE, Zurich (CH)

(21) Appl. No.: 12/300,429

(22) PCT Filed: May 15, 2007
(86) PCT No.: PCT/CH2007/000248

§ 371 Date: Jan. 7, 2009

Related U.S. Application Data
(60) Provisional application No. 60/747,480, filed on May 17, 2006.

(51) Int. Cl. G06F 3/042; G06F 3/041

(52) U.S. Cl. 345/175; 345/173

(57) ABSTRACT

An arrangement for displaying information on a display surface is provided, the arrangement including a computing unit and a projecting unit. The computing unit is capable of supplying a display control signal to the projecting unit to thereby cause the projecting unit to project a display image calculated by the computing unit onto the display surface. The arrangement further includes a detecting unit, the detecting unit being capable of detecting a pointing signal applied to the display surface by a user and of supplying, depending on the pointing signal, a pointing information to the computing unit. The computing unit can calculate the display image including at least one image unit, wherein at least one of the position, the size and of the shape of the at least one image unit is dependent on the pointing information.

This application is a national stage application of PCT/CH2007/000248 filed internationally on May 15, 2007, which claims priority to U.S. provisional patent application 60/747,480, filed on May 17, 2006, the content of which is incorporated herein by reference in its entirety.

### BACKGROUND OF THE INVENTION

1. Field of the Invention

The invention is in the field of displays. It especially relates to an arrangement and to methods for displaying information on a display field in an interactive manner.

2. Description of Related Art

Computer technology is increasingly migrating from traditional desktops to novel forms of ubiquitous displays on tabletops and walls of our environments. This process is mainly driven by the desire to lift the inherent limitations of classical computer and home entertainment screens, which are generally restricted in size, position, shape and interaction possibilities. There, users are required to adapt to given setups, instead of the display systems continuously accommodating the users' needs and wishes. Even though there have been efforts to alleviate some of the restrictions, the resulting displays are still confined to rectangular screens, do not tailor the displayed information to specific desires of users, and generally do not provide a matching set of dynamic multi-modal interaction techniques.

### BRIEF SUMMARY OF THE INVENTION

It is an object of the invention to provide an arrangement and a method of displaying information on a display surface, which support interactive displaying.

According to a first aspect of the invention, an arrangement for displaying information on a display surface is provided, the arrangement comprising a computing unit and a projecting unit. The computing unit is capable of supplying a display control signal to the projecting unit and to thereby cause the projecting unit to project a display image calculated by the computing unit onto the display surface. The arrangement further includes a detecting unit, the detecting unit being capable of detecting a pointing signal applied to the display surface by a user and of supplying, depending on the pointing signal, pointing information to the computing unit. The computing unit can calculate the display image including at least one image unit, wherein at least one of the position, the size and of the shape of the at least one image unit is dependent on the pointing information.

Especially preferred are embodiments, where the image unit or at least one image unit has a non-rectangular shape, especially a user-definable, arbitrary contiguous shape. Also, preferably the arrangement supports the display of a plurality of image units, the image units being arranged at a distance from each other. The arrangement may allow for an embodiment where between the image units essentially no (visible) light is projected apart from an ordinary (white) lighting of the display surface. The display surface is preferably horizontal and may also serve as work space, for example, as a desk.

According to another aspect of the invention, an arrangement for displaying information on a display surface is provided, the arrangement comprising a computing unit and a display unit, the computing unit capable of supplying a display control signal to the display unit, the display control signal being operable to cause the display unit to generate a display image calculated by the computing unit on the display surface, the arrangement further including a detecting unit, the detecting unit being capable of detecting a pointing signal applied to the display surface by a user and of supplying, depending on the pointing signal, a pointing information to the computing unit, the computing unit further being capable of calculating the display image including at least one image unit of non-rectangular shape, wherein at least the shape of the at least one image unit is dependent on
the pointing information, or
on the position of a physical element on the display surface or at a distance therefrom, detected by the detecting unit, or
on the pointing information and on the position of a physical element on the display surface or at a distance therefrom, detected by the detecting unit.

According to a third aspect of the invention, a method for displaying information on a display surface is provided, the method comprising:
projecting a display image including at least one image unit onto a display surface;
continuously and automatically watching the display surface for a pointing signal applied by a user; and
computing the display image dependent on the pointing signal, wherein at least one of the position, of the size and of the shape of the at least one image unit is computed dependent on the pointing information.

According to an even further aspect, a method for displaying information on a display surface is provided, the method comprising:
choosing a display image including at least one image unit of non-rectangular shape;
displaying the display image on a display surface;
continuously and automatically watching the display surface for a pointing signal applied by a user or for a physical element on the display surface or at a distance therefrom or for a pointing signal applied by a user and for a physical element on the display surface or at a distance therefrom, thereby obtaining watching information; and
   computing the display image, wherein the shape of the at least one image unit is computed dependent on the watching information.

According to yet another aspect of the invention, a method for displaying information is provided, the method comprising:
computing a display image including at least one image unit, the image unit having a non-rectangular shape;
providing a display content of a first shape;
providing a core area for the image unit, the core area having a second, non-rectangular shape, the first shape encompassing the second shape;
providing a peripheral region of the image unit, the peripheral region surrounding the core area; and
mapping display content portions outside the first shape onto the peripheral region, wherein said mapping includes displacing image points along non-intersecting mapping lines to a position within the peripheral region.

According to a further aspect of the invention, a computer-readable medium is provided, the computer-readable medium comprising program code capable of causing a computing unit of a display system to carry out the acts of
computing a display image including at least one image unit;
supplying a display control signal to a projecting unit, the display control signal causing the projecting unit to project the display image onto a display surface;
acquiring pointing information provided by a detecting unit, the pointing information being representative of a pointing signal applied to the display surface by a user;
of re-calculating the at least one of the position, of the size, and of the shape of the at least one image unit dependent on the pointing information.

According to yet another aspect, a computer-readable medium is provided, the computer-readable medium comprising program code capable of causing a computing unit to compute a display image including at least one image unit, the image unit having a non-rectangular shape, and to further carry out the acts of:
providing a display content of a first shape;
providing a core area for the image unit, the core area having a second, non-rectangular shape, the first shape encompassing the second shape;
providing a peripheral region of the image unit, the peripheral region surrounding the core area; and
mapping display content portions outside the first shape onto the peripheral region, wherein said mapping includes displacing image points along non-intersecting mapping lines to a position within the peripheral region.

The computing unit according to all aspects does not need to be a single element in a single housing. Rather, it is defined by its functionality and encompasses all devices that compute and/or control. It can be distributed and may include (elements of) more than one computer. It can even include elements that are arranged in a camera and/or in a projector, such as signal processing stages of a camera and/or projector.

In accordance with a preferred embodiment, the arrangement/method/software includes means for ensuring that the image units are not projected onto disturbing objects on the display surface. In general, projection surfaces, especially in tabletop settings, are not always guaranteed to provide an adequately large, uniform and continuous display area. A typical situation in a meeting or office environment consists of cluttered desks, which are covered with many objects, such as books, coffee cups, notepads and a variety of electronic devices. There would be several strategies for a projected display to deal with objects on a desk: First, ignore them and therefore get distorted images. Second, integrate the objects into the display scene as part of the projection surface in an intelligent way, unfortunately often resulting in varying reflection properties. Or third, be aware of the clutter and do not project imagery onto it. In accordance with the preferred embodiment, the third solution is realized. Surface usage is maximized by allowing displays to smoothly wind around obstacles in a freeform manner. As opposed to distorted projections resulting from ignoring objects on the desks, the deformation is entirely controllable and modifiable by the user, providing her maximum flexibility over the display appearance.

### BRIEF DESCRIPTION OF THE DRAWINGS

In the following, embodiments of the invention are described with reference to drawings. In the drawings:

FIG. 1 shows an arrangement for displaying information in an interactive environment-aware manner;

FIG. 2 shows an arrangement for displaying information comprising a plurality of modules;

FIG. 3. illustrates a display surface with two image units thereon;

FIG. 4 illustrates the warping operation mapping a display content with a rectangular shape onto an image unit of arbitrary shape;

FIG. 5 shows an image unit with a peripheral section C of a fixed width;

FIG. 6 illustrates a freeform editing operation;

FIG. 7 illustrates a display content alignment operation; and

FIG. 8 symbolizes a focus change operation.

### DETAILED DESCRIPTION OF THE PREFERRED EMBODIMENTS OF THE INVENTION

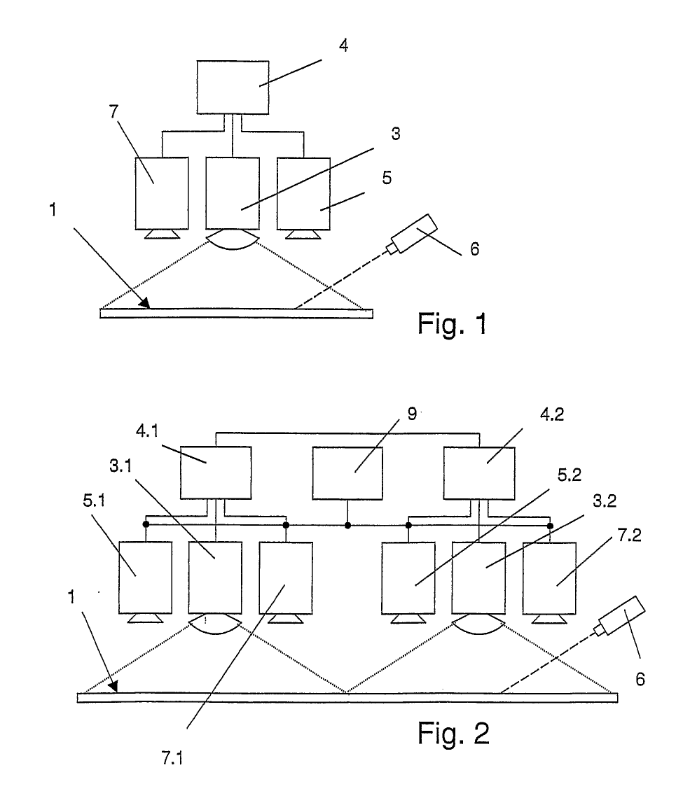

The arrangement illustrated in FIG. 1 is operable to display information on a display surface 1. To this end, the arrangement comprises a projecting unit, namely a projector 3. More generally, the projecting unit may comprise one or more projectors, for example one or more DLP (Digital Light Processing) devices and/or at least one other projector, such as at least one LCD projector, at least one projector based on a newly developed technology, etc.

As an alternative to a projector projecting a display image onto the display surface from the user accessible side (from “above”), it is also possible to have a projector projecting from the not accessible side (from “below” or from “behind”). Also, instead of at least one projector, other kinds of displays may be used, for example a large area LCD display, such as a tabletop LCD display. Further display methods are possible.

The projector is controlled by a computing unit 4, which may comprise at least one commercially available computer or computer processor or may comprise a specifically tailored computing stage or other computing means. The arrangement may further comprise at least one camera, namely two cameras in the shown embodiment.

A first camera 5 here is a color camera that is specifically adapted to track a spot projected by a laser pointer 6 onto the display surface 1. To this end, the first camera 5 may comprise a color filter specifically filtering radiation of the wavelength of the laser light produced by the laser pointer 6. Either the first camera 5 or the computing unit 4 may further comprise means for suppressing signals below a certain signal threshold in order to distinguish the laser pointer produced spot from other potential light spots on the display surface. As an alternative or in addition, distinction may be done by image analysis. In accordance with an embodiment, Kalman-filtered 3D laser pointer paths are reconstructed from real-time camera streams and the resulting coordinates are mapped to the appropriate image units. This allows users to interact with the image unit displays and their displayed content, both in a remote fashion and in the users' vicinity. Different methods of tracking a laser spot produced on a surface are known in the art, and the tracking of the laser pointer produced spot will therefore not be described in any more detail here. Of course, the first camera need not be a color camera but may be any other device suitable of tracking the spot of the pointing device.

Users can intuitively handle the display and possibly available menus such as a hierarchical on-screen menu which can be activated by triggering the pointer at locations where no image units are displayed. By handling the menus, the user may switch between the available operation modes. For example, if available, she may switch on and off an operation mode in which objects in the display surface are recognized and avoided (see below). Switching off of such an object recognition mode (where available) may be desired in situations where the user wants to point at image units with her finger.

Laser pointer tracking is advantageous, since in contrast to sensor-based surfaces or pen-based tracking, no invasive or expensive equipment is required. Furthermore, laser pointers have a very large range of operation.

The laser pointer 6 is an example of a pointing device by which a user may apply a pointing signal directly to the display surface. By the pointing device, the user may influence the shape or the position—preferably at least the shape, especially preferred both, the shape and the position—of image units, for example by pointing at a position on the display surface where an image unit is to appear, by illustrating a contour of an image unit on the display surface, or by relocating or deforming an existing image unit. The pointing device may optionally further serve as an input device by which user input may be supplied to the computing unit, for example in the manner of a computer mouse.

As an alternative to a laser pointer, other input devices may be used. As an example, the user may carry a traceable object attached to her hand or finger, so that she directly may use her hand as pointer device. As yet another alternative, the computing unit may be operable to extract, by image processing, information about the location of, for example, an index finger or a specially designed pointer (or touch tool or the like) from the picture collected by one of the cameras (such as the second camera 7), so that the index finger (or the whole hand or a pen or the pointer or the like) may serve as the pointing device.

As yet another alternative, the user may carry a device capable of determining its (absolute or relative) position and of transmitting this information to the computing unit. Also, the user may carry a passive element (tag) co-operating with an installation capable of determining the passive element's position. For these alternative embodiments, the device capable of determining an object on or above the display surface need not be a camera, but may also be some other position detecting device, such as a device that works by means of the transmission of electromagnetic signals, that includes a gyroscope, and/or a device that is based on other physical principles. The skilled person will know a lot of ways of detecting positions of an object.

It is an important advantage of the present invention that the pointing signal is applied directly to the display surface and need not be applied to a separate device (such as would be a computer input device of a separate computer). It is another advantage that not only the content but also the shape and/or position of the display (by way of the image units) may be influenced by pointing. It is yet another advantage of the present invention that by way of the arrangement according to the invention a display becomes possible which does not have a fixed outer shape (usually the shape of a rectangle), but which comprises an image unit or image units that adaptively may be placed at (free) places where the user wants them to and/or where they do not collide with other objects on the display surface.

A second camera 7 of the arrangement in the embodiment described here is a grayscale camera for the extraction of display surface properties, and especially for determining the place and shape of objects on the display surface 1 or thereabove. A possible method of doing so will be described in somewhat more detail below. As an alternative to a grayscale camera, the camera may also be of a different kind, especially a color camera.

Also the first camera 5 and the second camera are communicatively connected to the computing unit 4, namely, the computing unit is operable to receive a measurement signal from the two cameras and to analyze the same. Also, the computing unit may be operable to control the cameras and/or to synchronize the same with each other and/or with the projector. Especially, the computing unit may be operable to synchronize the second camera 7 with the projector.

In the preferred embodiment illustrated in FIG. 1 (and in other embodiments, such as the one illustrated in FIG. 2 described below), the arrangement comprises (optional) means for continuously screening the display surface for objects thereon by means of the second camera 7. This is done using a technique allowing control of the appearance of the projection surface during a triggered camera exposure as described in the publications Proc. of IEEE/ACM International Symposium on Mixed and Augmented Reality 2004, IEEE Computer Society Press, pp. 100-109 (ISMAR04, Washington D.C., USA, Nov. 2-5, 2004) by D. Cotting, M. Naef, M. Gross, and H. Fuchs and Proc. of Eurographics 2005, Eurographics Association, pp. 705-714 (Eurographics 2005, Dublin, Ireland, Aug. 29-Sep. 2, 2005) by D. Cotting, R. Ziegler, M. Gross, and H. Fuchs, both being incorporated herein by reference. This control is done at the scale of individual projector pixels and in an imperceptible way, thus allowing structured light approaches not noticeable by the user. Concerning the technique—called “Imperceptible Structured Light” by the inventors, the reader is referred to the above-mentioned two documents; the technique will be summarized only shortly in this text.

In DLP projectors, each displayed pixel is generated by a tiny micro-mirror, tilting towards the screen to project light and orienting towards an absorber to keep the pixel dark. Gradations of intensity values are created by flipping the mirror in a fast modulation sequence, while a synchronized filter wheel rotates in the optical path to generate colors. By carefully selecting the projected intensities, one can control whether or not the mirrors for the corresponding pixels project light onto the scene during a predefined exposure time slot of a synchronized camera.

The core idea of the imperceptible pattern embedding is a dithering of the projected images using color sets appearing either bright or dark in the triggered camera, depending on the chosen pattern. Such color sets can be obtained for any conventional DLP projector by analyzing its intensity pattern using a synchronized camera. For more details refer to the two mentioned publications.

Optionally, the suitability of the surface for display may be checked by continuously analyzing its reflection properties and its depth discontinuities, which have possibly been introduced by new objects in the environment. Subsequently, the image units are moved into adequate display areas by computing collision responses with the surface parts, which have been classified as not admissible for display.

In order to determine the display surface properties of a scene, a static pattern, such as a stripe pattern, may be projected in an imperceptible way during operation (as mentioned above). One may thus actively include the projector into the determination of suitable surfaces. Since the pattern can be considered a spatially periodic signal with a specific frequency, its detection can be performed by applying an appropriately designed Gabor filter G to the captured image Im of the reflected stripes. The magnitude of the filter response G [symbol] Im will be large in continuous surfaces with optimal reflection properties, whereas poor or non-uniform reflection and depth discontinuities will result in smaller filter responses due to distortions in the captured patterns. After applying an erosion filter to the Gabor response and thresholding the resulting values, the non-optimal surface parts of the environment can be determined.

Further, the image units may be continuously animated using a simple, 2D rigid body simulation. The non-optimal surface parts may then be used as collision areas during collision detection computations of the image units. Colliding image units are repelled by the areas until no more collisions occur. During displacement of the image units, inter-unit collision detection and response is performed continuously in an analog way.

Shadow avoidance: Since shadows result in a removal of the projected stripe pattern and therefore in a low Gabor filter response, shadow areas are classified as collision areas. Thus, image units continuously perform a shadow avoidance procedure in an automatic way, resulting in constantly visible screen content.

In more sophisticated embodiments, recognition of objects on the display surface may be combined with intelligent object-dependent action by means of image processing. Especially, the arrangement may, based on reflectivity, texture, color, shape or other measurements distinguish between disturbing objects such as paper, coffee cups or the like on one side and user's hands on the other side. The computing unit may be programmed so that the image units only avoid the disturbing objects but do not evade a user's hand, so that the user may point to displayed items. The arrangement may provide the possibility to switch off this functionality.

FIG. 2 illustrates a possibility of a scale-up version of the arrangement of FIG. 1. The shown embodiment includes two modules each comprising a projector 3.1, 3.2, a computing stage 4.1, 4.2, a first camera 5.1, 5.2, and a second camera 7.1, 7.2. Each of the modules covers a certain section of the display surface 1, wherein the sections allocated to the two modules have a slight overlap. For large display surfaces, this set-up may be scaled up to an arbitrary number of modules.

The display surface, in general and for any embodiment of the invention, need not be a conventional, for example, rectangular surface. It rather may have any shape and does not even need to be contiguous. The display surface may be a vertical surface (such as a wall onto which the displayed information is projected). However, the advantages of the invention are particularly significant in the case where the display surface is horizontal and, for example, constituted by a surface of a desk or a plurality of desks. Often, the display surface will consist of the desktops of several desks. In the preferred example of a horizontal display surface, the projector(s) and/or the camera(s) may be ceiling-mounted, for example, by means of an appropriate rail or similar device attached to the ceiling.

The computing stages 4.1, 4.2 (which are for example computers, such as personal computers) of the modules are communicatively coupled to each other. In the shown embodiment, the arrangement further comprises a microcontroller 9 for synchronizing the clocks of the two (or more) modules. For example, the microcontroller may generate TTL (transistor-transistor logic) signals, which are conducted to the graphic boards capable of being synchronized thereby, and to the cameras as trigger signals. This makes possible a synchronization between the generation and the capturing of the image.

To achieve a seamless alignment of the display projections, the modules may be calibrated intrinsically and extrinsically with relation to each other. For this purpose, calibration for both cameras and projectors may be done by an approach based on a propagation of Euclidean structure using point correspondences embedded into binary patterns. Such calibration has for example been described by J. Barreto and K. Daniilidis in Proc. of OMNIVIS '04 and by D. Cotting, R. Ziegler, M. Gross, and H. Fuchs in the publication submitted herewith as integral part of the present application.

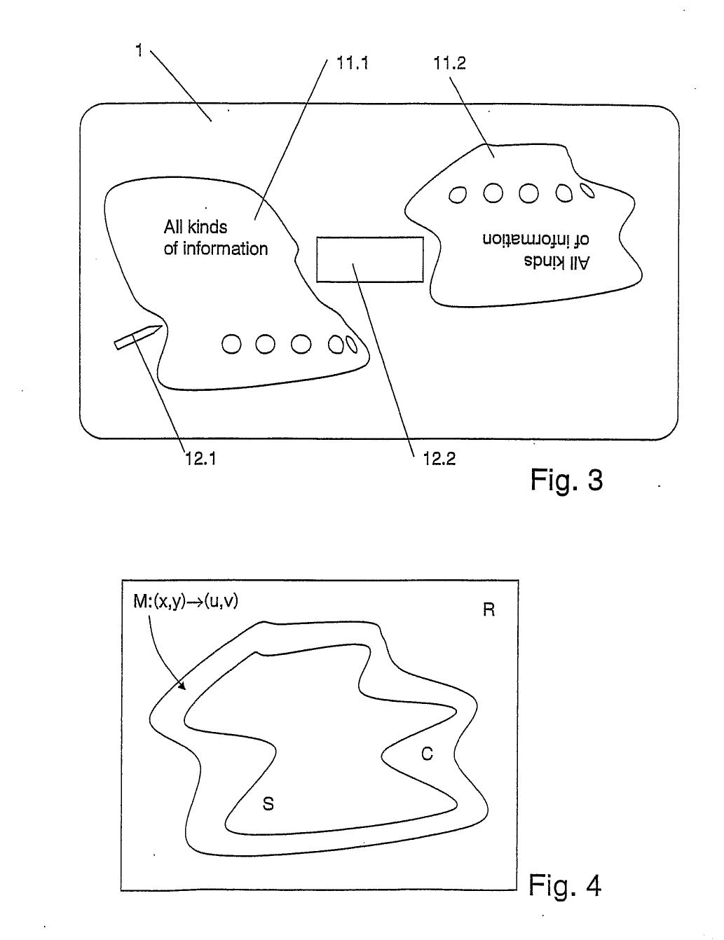

An example of a display surface 1 including two image units 11.1, 11.2 is very schematically illustrated in FIG. 3. In this embodiment, the display surface corresponds to the top of a single desk. The two image units 11.1, 11.2 may display, as is illustrated in FIG. 3, essentially the same information content, for example for two users working together at the desk. In addition or as an alternative, different image units may display different information. In the shown embodiment, the image units have arbitrary, not necessarily convex shapes. Also, in a peripheral region of the image units, the displayed image is distorted, the distortion being the smaller the distance to the boundary of the image unit, as will be explained in more detail further below.

In FIG. 3, objects 12.1, 12.2 are shown, which are placed on the tabletop. In the shown embodiment, which includes object recognition, the image units are shaped and positioned so that they evade the objects.

Even though the embodiment of the invention illustrated in FIG. 2 comprises two display modules and the display surface of FIG. 3 shows two image units, this does not mean that necessarily every image unit is displayed by a separate display module. On the contrary, often the arrangement will comprise one module only, and in either case one module may display more than one image unit. Also, an image unit may be jointly displayed by two modules, when it extends across a seam line between the display surface sections associated with different display modules, so that one display module may, for example, display a left portion of the image unit, and the other display module may display a right portion thereof.

Further, in case more than one camera and/or more than one projector is present, these devices need not be grouped in display modules. Rather, the field of vision of a camera need not coincide with the field illuminatable by a projector. For example, a camera may be operable to collect a picture of an area partially illuminated by more than one projector, or may collect a picture of a fraction of the area illuminated by one projector, etc.

Next, techniques to deform display content of usually rectangular shape into an image unit of arbitrary shape are described. In all variants of the technique described hereafter, the display content and the image unit area I are scaled such that the display content is represented on an a—usually but not necessarily rectangular—area R which encompasses the image unit area I.

In the following embodiments, the image unit is assumed to comprise a—for example user-defined and/or environment-adapted—core area S where the content information is displayed undistorted and a peripheral region C=ΛS surrounding the core area and in which information is displayed in a distorted manner. In the core area, the display content is displayed 1:1, with the possible exception of a scaling operation. The display content proportions outside the core area S are mapped onto the surrounding peripheral region C. To this end, a bundle of mapping lines is defined along which at least some of the points of the set difference R\S (also written as R−S={x: x∈R̂x∉S}) are displaced into the peripheral region C.

Thus, as illustrated in FIG. 4, given a core area forming an arbitrary closed shape S, where display content is optimally placed on the projection geometry a display mapping of the original rectangular screen content R is computed, such that:

a) The defined core area shape S displays enclosed content with maximum fidelity, i.e. least-possible distortion and quality loss;
b) The remaining content is smoothly arranged around the shape S in a controllable peripheral region C.

For this, for each pixel P(x,y) of the original screen content R its final position (u,v) under the aforementioned constraints has to be found. This problem corresponds to the action of image warping, which as such is known in computer graphics. Most traditional approaches to image warping utilize smooth geometric deformations guided by interactively set landmarks. Such traditional approaches may be used by an arrangement according to the invention. However, preferably, a newly developed method is used, which guarantees a smooth deformation while allowing to elegantly preserve the specific boundary conditions imposed by the application.

According to a first embodiment, the shape of the image unit(s) is chosen to be convex. In this embodiment, in a first step a central point of the image unit core area S is determined, the central point for example corresponding to the center of mass of S. Then, the mapping lines are chosen to be rays through the central points.

According to a second embodiment, the core area S has to be contiguous, but may have an arbitrary shape. In accordance with this second embodiment, a physical analogy is used for determining the mapping lines. More concretely, the mapping lines are chosen to be field lines of a two dimensional potential field that would arise between an object of the shape of the core area S being on a first potential and a boundary corresponding to the outer boundary ∂R of the display content R being on a second potential different therefrom.

The method, thus, constrains the mapping M to follow field lines in a charge-free potential field defined on the projection surface by two electrostatic conductors set to fixed, but different potentials V_{S} and V_{R}, where one of the conductors encompasses the area enclosed by S and the other one corresponds to the border of R. Without loss of generality, one may assume that V_{S}>V_{R}.

The first step in computing the desired mapping involves the computation of the 2-dimensional potential field V of the projection surface parameterization, which is given as the solution of the Laplacian equation

$$Δ V ( x , y ) ≡ \frac{{\partial }^{2} V}{\partial {x}^{2}} + \frac{{\partial }^{2} V}{\partial {y}^{2}} = 0$$

with the inhomogeneous boundary conditions V(∂S)=V_{S} and V(∂R)=V_{R}. Numerical methods for solving the Laplacian equation in this situation are known. For example, the potential may be computed using a finite difference discretization of the Laplacian on a regular, discrete M×N grid of fixed size. Iterative successive overrelaxation with Chebyshev acceleration may be employed. In fact, the Laplacian equation can be solved very efficiently on regular grids and the computational grid can be chosen smaller than the screen resolution, for example around 100×100 only.

Then, when determining the position (u,v), where a certain pixel P(x,y) of the original display content R should be warped to, the corresponding field lines of the gradient field of V computed from the discrete potential values towards the area S may be followed, the field lines serving as the mapping lines. A simple Euler integration method may be used to trace the field lines. The field lines exhibit many desired properties, such as absence of intersections, smoothness and continuity except at singularities such as point charges, which cannot occur in the present charge-free region.

Once the mapping lines are known, one has to determine the exact location, where each pixel of the original rectangular display will be warped to on the mapping line. To this end, one may use focus and context visualization techniques as such known in the art, in particular from the area of hyperbolic projection.

Every pixel inside S keeps its location and is thus part of the core area (or focus area), which displays the enclosed content with maximum fidelity and least-possible quality loss. For every pixel P(x,y) outside the core area, its potential is determined, and given a user-defined parameter V_{Δ}, the pixel may be moved along its mapping line to the position (u,v) with potential

$${V}_{M} = {V}_{S} - \frac{{V}_{S} - {V}_{P}}{\sqrt{{( \frac{{V}_{S} - {V}_{P}}{{V}_{Δ}} )}^{2} + 1}}$$

which corresponds to a hyperbolic projection of the potential difference V_{S}-V_{P} between the point P and the focus area S.

The resulting mapping provides a smooth arrangement of the set difference R\S around the core area S in an intuitive peripheral region as context area C, which can be controlled by a user-defined parameter V_{Δ} influencing the border of the context area C. When the user parameter is converging to 0, the peripheral region disappears and the warping corresponds to a clipping with S as a mask. If V_{Δ} goes towards infinity, the original rectangular shape is maintained. The hyperbolic projection has some interesting properties, in that pixels near S are focused, while an infinite amount of space can be displayed within an arbitrary range C defined by V_{Δ}. Note that the above equation for V_{M} guarantees that no seams are visible between the focus and the context area, and thus, ensures visual continuity.

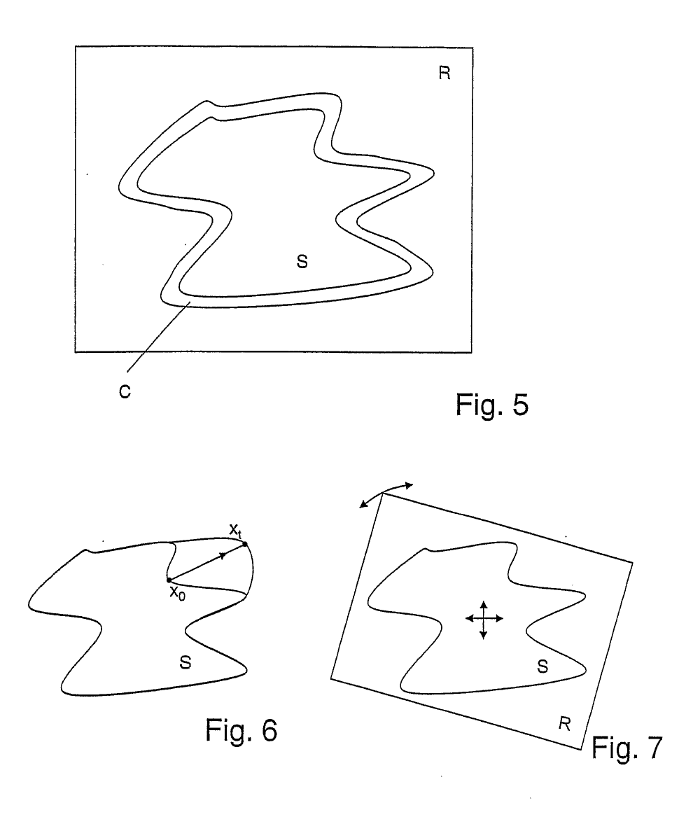

If a constrained width of the context area C is required, geometric distance along the field line can be used instead of the potential difference during the hyperbolic projection. Here, the distances are computed by adding the spatial differences while tracing the field lines using Euler integration. Each pixel P(x,y) outside the core area with distance D_{PS} to S along its mapping line is therefore mapped to the point on the line at distance

$${D}_{M} = \frac{{D}_{PS}}{\sqrt{{( \frac{{D}_{PS}}{{D}_{Δ}} )}^{2} + 1}}$$

where the user-defined parameter D_{Δ} specifies the width of the context area C along the field lines. In FIG. 5, a resulting peripheral region C (context areas) of the distance based approach is illustrated, in contrast to the peripheral region C of FIG. 4 which results from a potential difference based approach.

In order to be quick, not every pixel's mapping need to be calculated, but rather discrete locations of a warping grid may be evaluated and the remaining pixels interpolated through hardware accelerated texture mapping. For an average potential field grid and warping grid, due to this interpolation, the computation time using a computer with a single commercially available 3 GHz processor is of the order of 20-300 milliseconds.

Above-mentioned interpolation allows for interactive recomputation of the warping such as being needed for image unit deformation, and also performs high-quality antialiasing. This feature may be of help to attenuate aliasing artifacts arising when resealing an image unit with fineprint text.

The so far described components of the invention all relate to approaches how to display information (content). Preferred embodiments of the invention further include features which allow to generate content to be displayed in accordance with the invention from different sources. To this end, an approach for distributed display, which relies on an efficient and scalable transmission based on a protocol such as the Microsoft RDP protocol, may be used, as is described in D. Cotting, R. Ziegler, M. Gross, and H. Fuchs submitted herewith as an integral part of the present application. The protocol provides support for the cross-platform VNC protocol, user-defined widgets and lighting components. The RDP and VNC (or alternative) protocols allow content of any source computer to be visualized remotely without requiring a transfer of data or applications to the nodes of the image unit system. As a major advantage, this allows us to include any laptop as a source for display content in a collaborative meeting room environment.

Widgets represent small self-contained applications giving the user continuous, fast and easy access to a large variety of information, such as timetables, communication tools, forecast or planning information.

As a complement to the protocols generating the actual display content, lighting components may allow users to steer and command, for example, bubble-shaped light sources as a virtual illumination in their tabletop augmented reality environments.

Each content stream, consisting of one of the aforementioned protocols, can be replicated to an arbitrary number of image units which can be displayed by multiple nodes concurrently. This versatility easily allows multiple users to collaborate on the same display content simultaneously.

In the following, examples of user initiated operations influencing the location and/or shape of image units are described in somewhat more detail. All examples rely on the above-described embodiment of a pointing tool being a laser pointer, but they may equally well be implemented by other pointing means, as previously mentioned.

Warping operations: In preferred embodiments, the set of warping parameters of a currently selected image unit can be changed dynamically. For example, the curve defining the focus area S may be deformable. Also, the potential V_{Δ} may be modifiable. One may further allow the rectangle R to be realigned with respect to S, and the content which appears in focus to be interactively changed.

As a first example of a warping operation, a freeform editing operation is illustrated in FIG. 6. The self-intersection free curves, which define the focus area of the image units, can be manipulated by the user in a smooth, direct, elastic way. Given a pointer position L₀=(u₀, v₀) in the screen geometry parameterization at the beginning of a freeform editing step and a position Lₜ=(uₜ, vₜ) at time, the deformed positions of the curve points Pᵢ are given by

$${P}_{i}^{′} ( t ) = {P}_{i} + exp ( - \frac{{( {P}_{i} - {L}_{0} )}^{2}}{2 {σ ( t )}^{2}} ) \cdot ( {L}_{t} - {L}_{0} )$$

where σ(t) specifies the Gaussian falloff of the smooth displacement kernel and is defined as σ(t)=∥Lₜ−L₀∥. This variable factor provides a simple form of adaptivity of the edit support with respect to the magnitude of displacement of an editing step at time t. The user can dynamically move the pointer and preview the new shape of the focus area in real-time until she is satisfied with its appearance. After the user acknowledges an editing step at a certain time t′ by releasing the laser pointer, the coordinates Pᵢ′(t′) are applied and the curve is resampled if required. Subsequently, the new warping parameters are computed for the newly specified focus. It is needless to say that other curve editing schemes, such as control points, could be accommodated easily.

A further user-defined warping operation is the adapting of the user-defined potential parameter V_{Δ}, allowing a continuous change in image unit shape from the unwarped rectangular screen to the shape of the core area. This allows the user to continuously choose her favored representation according to her current tasks and preferences.

Yet another user-defined warping operation is the alignment of display content (or “rectangle alignment”). If the position of an image unit has to remain constant, but the content should be scaled, translated and rotated, then the display content (here: rectangle) R can be zoomed, moved or spun around the shape S as shown in FIG. 7. If required, the rectangle's size can be continuously adapted so that it entirely contains S.

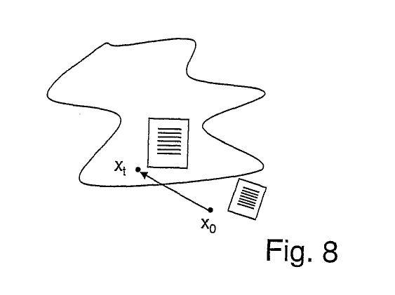

A further user-defined warping operation is the focus change, as schematically illustrated in FIG. 8. The user may dynamically redefine the content of the core area in real-time by moving the texture of the original display content R by a displacement vector v=Lₜ−L₀, where L₀ represents the laser pointer position in the screen geometry parameterization at the beginning of a focus and context editing operation step and Lₜ corresponds to the position at the time t>0. This allows the user to freely navigate around extensive content and also facilitates exploration of large desktops where unused information of inactive applications can be parked in the peripheral region C. Switching from one information or application to another is then as easy as changing focus (i.e. displacing the core area).

Image unit arrangement: At the user's discretion, the image units can, according to special embodiments, be transformed and arranged in various ways.

A first example is affine transformations. With the help of the laser pointer, the image units can be scaled, changed in aspect-ratio, rotated and translated to any new location on the projection surface. Additionally, the image units can be pushed in a rigid body simulation framework by assigning them a velocity vector proportional to the magnitude of a laser pointer gesture.

A second example is grouping. As a more elaborate arrangement operation, multiple image units may be marked for grouping by elastic bonds, allowing the users to treat semantically related displays in a coupled way. After grouping, the linked image units may be programmed to immediately be gathering due to the mutual spring forces.

It is possible to change the cardinality (number) of the image units: The cardinality of the set of currently displayed image units can be changed in multiple ways, such as instantiation, cloning, deletion, cut and pasting.

New image units can be created with the laser pointer by tracing a curve defining a new core area S. The display content R, which is required for the warping computation, is automatically mapped around this curve as a slightly enlarged bounding box. It can subsequently be aligned with the alignment operation presented above, and the displayed content can for example be chosen with the content cycling shortly described hereafter.

An image unit can be cloned by dragging a copy to the desired location.

Multiple image units can be marked for deletion by subsequently pointing at them.

By pointing at one or multiple image units in a sequence, the user can mark a set of displays for a cut operation, which stores the affected image units into a persistent buffer, which can be pasted onto the projection surface an arbitrary number of times at any desired location.

Application interface: the arrangement according to the invention may, according to preferred embodiments, feature functionality of an application interface which allows operations such “mouse” navigation, keyboard tracing, annotation and context cycling.

Mouse events can, for example, be dispatched to the protocols being used for display content generation. For that purpose, the laser pointer location in the screen geometry parameterization may be transformed to image unit coordinates, then unwarped by an inverse operation of the above-described mapping operation (i.e. image points are displaced back along the mapping lines) while the focus parameters are accounted for in order to recover the correct corresponding application or widget screen coordinates. Mouse locations at the border of the screens automatically initiate a scrolling of the image contents by dynamically adjusting the focus. To trigger events, a second laser modulation mode provided by the pointer may be used.

For textual input in multi-user collaborative environments, keyboarding may be introduced into tabletop settings. Trajectories of words traced by the user on an configurable, optimized keyboard layout, which is overlaid on the image may be recognized and matched to an internal database. Both shape and location information may be considered, and if multiple word candidates remain, the user is given the option to select one from a list of most probable candidates. Due to the intuitive and deterministic nature of the input method, the user can gradually transition from visually-guided tracing to recall-driven gesturing. After only a short training period, the approach requires very low visual and cognitive attention and offers high input rate compared to alternative approaches. Additionally, in contrast to previous methods, it does not require any cumbersome separate input device. As further advantages, it provides a degree of error resilience suited for the limited precision of the laser pointer based remote interaction. Note that it is possible to use conventional (potentially wireless) keyboards within an arrangement according to the invention as well.

Using the pointing device, users can draw on the contents of image units to apply annotations, which are mirrored to all image units displaying the same content.

The content of each image unit can further be changed by cycling through a predefined set of concurrently running protocols. This allows users to switch from one content to the next on the fly depending on the upcoming tasks, and also permits swapping contents between image units.

Further aspects of the invention are described in Proc. of ACM UIST 2006, ACM Press, pp. 245-254. (ACM Symposium on User Interface Software and Technology 2006, Montreux, Switzerland, Oct. 15-Oct. 18, 2006), which publication is incorporated herein by reference.

1. An arrangement for displaying information on a display surface, the arrangement comprising:
a computing unit; and
a display unit,
wherein the computing unit is capable of supplying a display control signal to the display unit,
wherein the display control signal is operable to cause the display unit to generate a display image calculated by the computing unit on the display surface,
the arrangement further comprising a detecting unit, the detecting unit being capable of detecting a pointing signal applied to the display surface by a user and of supplying, depending on the pointing signal, a pointing information to the computing unit, and
the computing unit further being capable of calculating the display image including at least one image unit of non-rectangular shape, wherein at least the shape of the at least one image unit is dependent on
the pointing information, or
on the position of a physical element on the display surface or at a distance therefrom, detected by the detecting unit, or
on the pointing information and on the position of a physical element on the display surface or at a distance therefrom, detected by the detecting unit.

2. An arrangement according to claim 1, wherein the detecting unit comprises at least one camera operable to collect a picture of at least a section of the display surface.

3. An arrangement according to claim 2, wherein the computing unit is capable of determining at least one of the position, the size and of the shape of the at least one image unit dependent on content of the picture collected by the at least one camera.

4. An arrangement according to claim 3, wherein an object which can be detected by the detecting unit is a light point projected onto the display surface by a pointing device and serving as the pointing signal.

5. An arrangement according to claim 3, wherein an object which can be detected by the detecting unit is a physical element on the display surface or at a distance therefrom.

6. The arrangement according to claim 5, wherein the computing unit is operable to position or shape or position and shape the at least one image unit so that at least a core region of the image unit is not displayed onto such element.

7. The arrangement according to claim 3, wherein the detecting unit comprises at least two different cameras, the detecting unit being capable of detecting from a picture collected by at least one of said cameras, a light point projected onto the display surface by a pointing device, and being capable of detecting from a picture of at least an other one of said cameras a physical element on the display surface or at a distance therefrom.

8. The arrangement according to claim 3, further comprising a plurality of modules, each module including a display device and at least one camera.

9. The arrangement according to claim 1, wherein the image includes a plurality of image units arranged at a distance from each other, and wherein in a space between the image units is empty and free of displayed information.

10. The arrangement according to claim 1, wherein the computing unit is operable to provide at least one image unit in a non-rectangular, user definable shape.

11. The arrangement according to claim 1, wherein the computing unit is operable to perform on an image unit at least one of the following operations in accordance with a pointing signal applied to the display surface by the user:
deforming the outer shape,
relocating the image unit,
multiplying the image unit,
deleting the image unit,
relocating or rotating the display content relative to the core region.

12. The arrangement according to claim 1, wherein the computing unit is operable to map a core of a display content onto a core region of the image unit and is further operable to map display content adjacent to the core onto a peripheral region of the image unit.

13. The arrangement according to claim 12, wherein mapping the display content adjacent to the core onto the peripheral region of the image unit includes displacing image points along non-intersecting mapping lines.

14. The arrangement according to claim 13, wherein the mapping lines are rays through a central point of the core area.

15. The arrangement according to claim 13, wherein the mapping lines are lines corresponding to field lines of a gradient vector field of a physical potential field V obeying the Laplacian equation ΔV(x,y)=0, where Δ is the Laplacian differential operator.

16. The arrangement according to claim 13, wherein the image points are displaced in accordance with the principle of hyperbolic projection.

17. The arrangement according to claim 1, wherein the display surface is horizontal.

18. An arrangement for displaying information on a display surface, the arrangement comprising:
a computing unit, and
a projecting unit,
wherein the computing unit is capable of supplying a display control signal to the projecting unit,
wherein the display control signal is operable to cause the projecting unit to project a display image calculated by the computing unit onto the display surface,
the arrangement further including a detecting unit, the detecting unit being capable of detecting a pointing signal applied to the display surface by a user and of supplying, depending on the pointing signal, a pointing information to the computing unit,
the computing unit further being capable of calculating the display image including at least one image unit,
wherein at least one of the position, the size and of the shape of the at least one image unit is dependent on the pointing information.

19. An arrangement according to claim 18, wherein the detecting unit is capable of detecting an object on the display surface or at a distance therefrom.

20. A method for displaying information on a display surface, comprising the steps of:
projecting a display image including at least one image unit onto a display surface;
continuously and automatically watching the display surface for a pointing signal applied by a user; and
computing the display image dependent on the pointing signal, wherein at least one of the position, of the size and of the shape of the at least one image unit is computed dependent on the pointing information.

21. A method for displaying information on a display surface, comprising the steps of:
choosing a display image including at least one image unit of non-rectangular shape;
displaying the display image on a display surface;
continuously and automatically watching the display surface for a pointing signal applied by a user or for a physical element on the display surface or at a distance therefrom or for a pointing signal applied by a user and for a physical element on the display surface or at a distance therefrom, thereby obtaining watching information; and
computing the display image, wherein the shape of the at least one image unit is computed dependent on the watching information.

22. A method for displaying information comprising the steps of:
computing a display image including at least one image unit with a non-rectangular shape;
providing a display content of a first shape;
providing a core area for the image unit, the core area having a second, non-rectangular shape, the first shape encompassing the second shape;
providing a peripheral region of the image unit, the peripheral region surrounding the core area; and
mapping display content portions outside the first shape onto the peripheral region, wherein said mapping includes displacing image points along non-intersecting mapping lines to a position within the peripheral region.

23. The method according to claim 22, wherein said mapping lines are chosen to be field lines of a gradient vector field of a physical potential field V obeying the Laplacian equation ΔV(x,y)=0, where Δ is the Laplacian differential operator.

24. The method according to claim 23, wherein an outer boundary of the first shape is set to a first potential value V_{S} and wherein an outer boundary of the display content is set to a second potential value V_{R}.

25. The method according to claim 24, wherein an outer boundary of the peripheral region is chosen to be a line defined by a constant potential value, the constant potential value being between the first potential value and the second potential value.

26. The method according to claim 22, wherein an outer boundary of the peripheral region is chosen to be at a constant distance from an outer boundary of the core area.

27. A computer-readable medium comprising program code capable of causing a computing unit of a display system to carry out the acts of:
computing a display image including at least one image unit;
supplying a display control signal to a display unit, the display control signal causing the projecting unit to display the display image on a display surface;
acquiring a pointing information provided by a detecting unit, the pointing information being representative of a pointing signal applied to the display surface by a user;
of re-calculating the at least one of the position, of the size, and of the shape of the at least one image unit dependent on the pointing information.

28. A computer-readable medium comprising program code capable of causing a computing unit to compute a display image including at least one image unit, the image unit having a non-rectangular shape, and to further carry out the acts of:
providing a display content of a first shape;
providing a core area for the image unit, the core area having a second, non-rectangular shape, the first shape encompassing the second shape;
providing a peripheral region of the image unit, the peripheral region surrounding the core area; and
mapping display content portions outside the first shape onto the peripheral region, wherein said mapping includes displacing image points along non-intersecting mapping lines to a position within the peripheral region.
